(19) United States
(12) Patent Application Publication
(10) Pub. No.: US 2022/0192149 A1
(43) Pub. Date: Jun. 23, 2022

(54) WATER STORAGE TANK AND ANIMAL WATER FOUNTAIN

(71) Applicant: Shenzhen Jincan Pet Products CO., LTD, Shenzhen (CN)

(72) Inventor: Xiaocan TAO, Shenzhen (CN)

(73) Assignee: Shenzhen Jincan Pet Products CO., LTD, Shenzhen (CN)

(21) Appl. No.: 17/551,161

(22) Filed: Dec. 14, 2021

(30) Foreign Application Priority Data
Dec. 18, 2020 (CN) 202023089344.4

(51) Int. Cl. A01K 7/02; C02F 1/00

(52) U.S. Cl. CPC A01K 7/025; C02F 2103/20; C02F 1/001

(57) ABSTRACT

A water storage tank includes a water storage tank body; the water storage tank body is defined with a liquid storage chamber for storing a liquid and for receiving a water pump, and an opening communicating with the liquid storage chamber; an open groove for allowing a power line to pass through is formed in the water storage tank body; and the open groove penetrates through an end edge of the water storage tank body close to the opening. Since the power line can be led out from the liquid storage chamber by directly clamping into the open groove from top to bottom, the power line is arranged conveniently and there is no need to provide a wiring box or a wiring groove for the power line.

### CROSS-REFERENCE TO RELATED APPLICATIONS

This application claims priority to Chinese Patent Application No. 202023089344 with a filing date of Dec. 18, 2020. The content of the aforementioned application, including any intervening amendments thereto, is incorporated herein by reference.

### TECHNICAL FIELD

The disclosure relates to the technical field of automatic animal feeding, and in particular, to a water storage tank and an animal water fountain.

### BACKGROUND

Animal water fountains are automatic water feeders provided for animals to drink water, and are particularly applied to pets such as cats and dogs for water drinking. Generally, an animal water fountain includes a water storage tank, a water pump, a water filter tray and a drinking water tray, etc. The water pump pumps water in the water storage tank to the drinking water tray for animal drinking, water in the drinking water tray flows to the water filter tray to filter and remove impurities, foreign matters and so on, and water filtered by the water filter tray flows back to the water storage tank again, thereby forming a circulation.

For existing animal water fountains, since the water pump is arranged in the water storage tank, a wiring box or a wiring groove connected to the water storage tank is additionally arranged in the water storage tank for the power line of the water pump. This causes high manufacturing costs, laborious arrangement of the power line, and low assembly efficiency. Moreover, the wiring box or the wiring groove is often provided at the bottom of the water storage tank, which makes the structure of the water storage tank complicated, with inconvenience for cleaning. Therefore, there are many problems arising from the inconvenience of arranging the power line of the water pump on the water storage tank.

### SUMMARY

An objective of the disclosure is to provide a water storage tank for solving the technical problem that the power line of the water pump is arranged on the water storage tank inconveniently in the prior art.

To achieve the above-mentioned objective, the disclosure adopts the following technical solutions: a water storage tank is provided, which is applied to an animal water fountain, the animal water fountain includes a water pump having a power line; the water storage tank includes a water storage tank body; the water storage tank body is defined with a liquid storage chamber for storing a liquid and for receiving the water pump, and an opening communicating with the liquid storage chamber; an open groove for allowing the power line to pass through is formed in the water storage tank body; and the open groove penetrates through an end edge of the water storage tank body close to the opening.

In an embodiment, the open groove may comprise a bottom wall, and the bottom wall may be inclined toward the liquid storage chamber from an outside of the water storage tank body.

In an embodiment, the open groove may comprise a bottom wall, and the bottom wall may be of an arc shape.

In an embodiment, the water storage tank may include a clamping portion, the clamping portion may be arranged on an outer surface of the water storage tank body, and the clamping portion may comprise a bayonet for clamping the power line.

In an embodiment, the water storage tank body may include: a bottom wall portion and a sidewall portion, wherein the sidewall portion is internally hollow; one end of the sidewall portion is connected to the bottom wall portion, such that the sidewall portion and the bottom wall portion are enclosed to form the liquid storage chamber; the other end of the sidewall portion services as the opening; the open groove is formed in the sidewall portion and close to the opening; and the open groove penetrates through an end edge of the sidewall portion close to the opening.

In an embodiment, the water storage tank may include a connecting portion connected to the water pump, and the connecting portion may be located in the liquid storage chamber and arranged on a bottom surface of the water storage tank body.

In an embodiment, the water pump may comprise a locating hole, the connecting portion may be a locating post matching with the locating hole of the water pump, and the locating post may protrude from the bottom surface of the water storage tank body.

In an embodiment, the water storage tank may include a limiting portion for limiting the water pump, and the limiting portion may be located in the liquid storage chamber and arranged on a bottom surface of the water storage tank body.

In an embodiment, the water storage tank body may be of a cylindrical shape.

Another objective of the disclosure is to provide an animal water fountain, including: the water storage tank in any of the above described embodiments; a water filter tray, arranged on the water storage tank, and including a filtrate chamber, the filtrate chamber communicating with the liquid storage chamber of the water storage tank; a drinking water tray, arranged on the water filter tray or the water storage tank, the water filter tray being located between the drinking water tray and the water storage tank, the drinking water tray including a liquid accommodation chamber, and the liquid accommodation chamber communicating with the filtrate chamber; and a water pump, arranged in the liquid storage chamber to pump a liquid in the liquid storage chamber to the liquid accommodation chamber, the water pump having a power line, and the power line penetrating through an open groove of the water storage tank.

The disclosure achieves at least the following technical effects or advantages with the above one or more technical solutions in the embodiments:

According to the water storage tank provided by the embodiment of the disclosure, the water storage tank body is defined with the liquid storage chamber and the opening, the water pump is arranged in the liquid storage chamber, and the open groove is formed in the water storage tank body, such that the power line of the water pump can extend to the outside through the open groove and thus is led out from the liquid storage chamber. Since the open groove penetrates through the end edge of the water storage tank body close to the opening, and the power line can be led out from the liquid storage chamber by directly clamping into the open groove from top to bottom, the power line is arranged conveniently and there is no need to provide a wiring box or a wiring groove for the power line; the water pump and the power line thereof are assembled quickly and conveniently on the water storage tank and there is no need to additionally provide the wiring box or the wiring groove, so the water storage tank provided by the embodiment of the disclosure can effectively reduce the manufacturing cost and improve the assembly efficiency; and moreover, since the power line can be led out by only providing the open groove, the disclosure effectively simplifies the structure of the water storage chamber, for ease of cleaning.

### BRIEF DESCRIPTION OF THE DRAWINGS

To describe the technical solutions in the embodiments of the disclosure more clearly, the following briefly introduces the accompanying drawings required for describing the embodiments or the prior art. Apparently, the accompanying drawings in the following description show merely some embodiments of the disclosure, and a person of ordinary skill in the art may still derive other drawings from these accompanying drawings without creative efforts.

FIG. 1 is a schematic structural view of a water storage tank according to an embodiment of the disclosure;

FIG. 2 is a schematic view of a local structure of an open groove in FIG. 1;

FIG. 3 is a schematic structural view of a water storage tank and a water pump in cooperation according to an embodiment of the disclosure;

FIG. 4 is a schematic structural view of an animal water fountain according to an embodiment of the disclosure; and

FIG. 5 is a sectional structural view of an animal water fountain according to an embodiment of the disclosure.

In the figures:

100. water storage tank, 10. water storage tank body, 101. liquid storage chamber, 102. opening, 103. open groove, 104. end edge, 1031. bottom wall, 1032. sidewall, 20. clamping portion, 201. bayonet, 11. bottom wall portion, 12. sidewall portion, 30. connecting portion, 40. limiting portion, 1000. animal water fountain, 200. water filter tray, 210. filtrate chamber, 220. filter element, 230. filtrate outlet, 300. drinking water tray, 310. liquid accommodation chamber, 320. water leaking port, 330. suction pipe, 3301. water inlet, 3302. water outlet, 400. water pump, and 410. power line.

### DETAILED DESCRIPTION OF THE EMBODIMENTS

The embodiments of the disclosure are described below in detail. Examples of the embodiments are shown in the accompanying drawings. The same or similar numerals represent the same or similar elements or elements having the same or similar functions throughout the specification. The embodiments described below with reference to the accompanying drawings are exemplary, are used only for explaining the disclosure, and should not be construed as a limitation to the disclosure.

In the description of the disclosure, it should be understood that orientations or position relationships indicated by terms “length”, “width”, “upper”, “lower”, “front”, “rear”, “left”, “right”, “vertical”, “horizontal”, “top”, “bottom”, “inside”, “outside”, and the like are orientations or position relationships as shown in the drawings, for ease of describing the disclosure and simplifying the description, rather than indicating or implying that the mentioned devices or elements must have a specific orientation and must be established and operated in a specific orientation, and thus, these terms cannot be understood as a limitation to the disclosure.

Moreover, the terms “first” and “second” are used only for the purpose of description and should not be construed as indicating or implying a relative importance, or implicitly indicating a quantity of indicated technical features. Thus, features defined with “first” and “second” may explicitly or implicitly include one or more of the features. In the description of the disclosure, “a plurality of” means two or more, unless otherwise specifically defined.

In the disclosure, unless otherwise clearly specified, the terms “installation”, “interconnection”, “connection” and “fixation” are intended to be understood in a broad sense. For example, the connection may be a fixed connection, removable connection or integral connection; may be a mechanical connection or electrical connection; may be a direct connection or indirect connection using a medium; and may be a communication or interaction between two elements. The person of ordinary skill in the art may understand the specific meanings of the above terms in the disclosure based on specific situations.

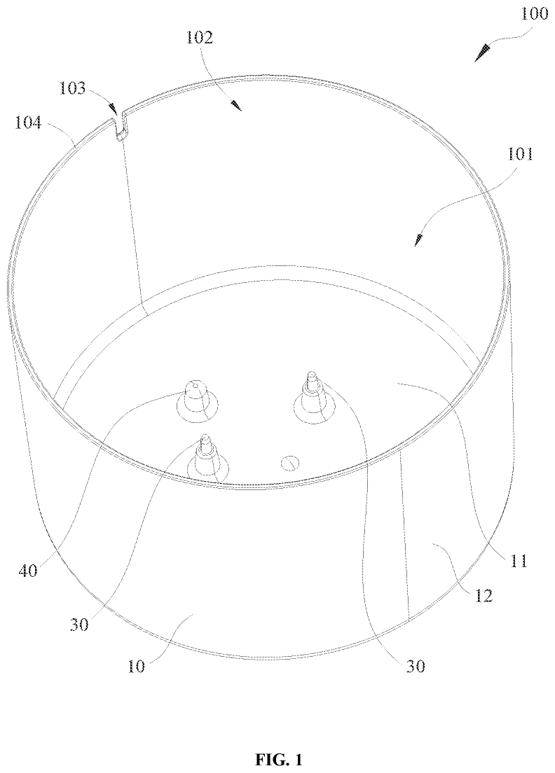

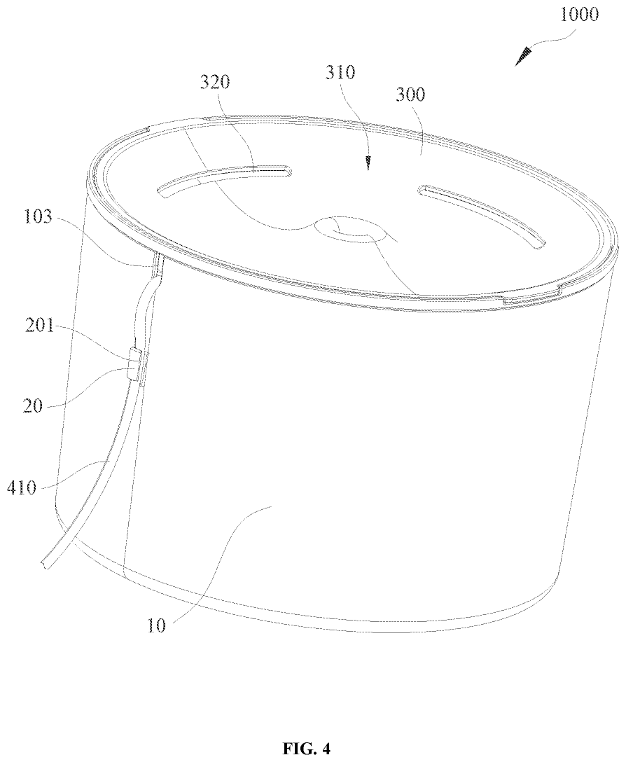

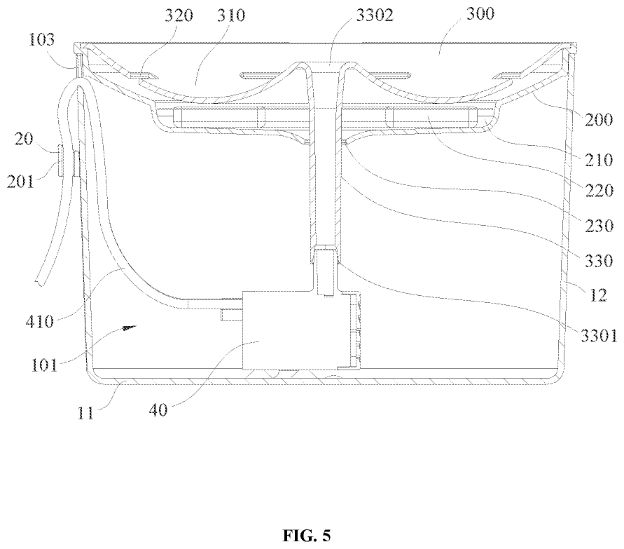

Referring to FIG. 1 to FIG. 5, the embodiment of the disclosure provides a water storage tank 100, which is applied to an animal water fountain. The animal water fountain includes a drinking water tray, a water filter tray, and a water pump having a power line. FIG. 4 and FIG. 5 exemplarily illustrate the animal water fountain 1000, the drinking water tray 300, the water filter tray 200, the water pump 400 and the power line 410. The water storage tank includes a water storage tank body 10. The water storage tank body 10 is defined with a liquid storage chamber 101 for storing a liquid and for receiving a water pump, and an opening 102 communicating with the liquid storage chamber 101. The drinking water tray and the water filter tray of the animal water fountain can be arranged on the water storage tank body 10 and close to the opening 102. The water pump is arranged in the liquid storage chamber 101, for example, on a bottom surface of the water storage tank body 10. An open groove 103 for allowing a power line to pass through is formed in the water storage tank body 10, and the open groove 103 penetrates through an end edge 104 of the water storage tank body 10 close to the opening 102.

According to the water storage tank 100 provided by the embodiment of the disclosure, the water storage tank body 10 is defined with the liquid storage chamber 101 and the opening 102, the water pump is arranged in the liquid storage chamber 101, and the open groove 103 is formed in the water storage tank body 10, such that the power line of the water pump can extend to the outside through the open groove 103 and thus is led out from the liquid storage chamber 101. Since the open groove 103 penetrates through the end edge 104 of the water storage tank body 10 close to the opening 102, and the power line can be led out from the liquid storage chamber by directly clamping into the open groove 103 from top to bottom, there is no need to provide the wiring box or the wiring groove for the power line; the water pump and the power line thereof are assembled quickly and conveniently on the water storage tank and there is no need to additionally provide the wiring box or the wiring groove, so the water storage tank provided by the embodiment of the disclosure can effectively reduce the manufacturing cost and improve the assembly efficiency as well as the production efficiency of the animal water fountain; and moreover, since the power line can be led out by only providing the open groove 103, the disclosure effectively simplifies the structure of the water storage chamber, for ease of cleaning. Additionally, since the open groove 103 is close to the opening 102, the upper portion of the power line can extend upward from the liquid level in the liquid storage chamber 101 and thus is led out from the liquid storage chamber 101; and therefore, compared with the scheme in which the wiring box or the wiring groove is formed in the bottom or the inner surface of the water storage tank in the prior art, the disclosure is safer. Meanwhile, when the drinking water tray and the water filter tray of the animal water fountain are arranged on the water storage tank body 10 and close the opening 102, the open groove 103 can be sealed, such that the power line can be limited in the open groove 103 to make the power line more stable.

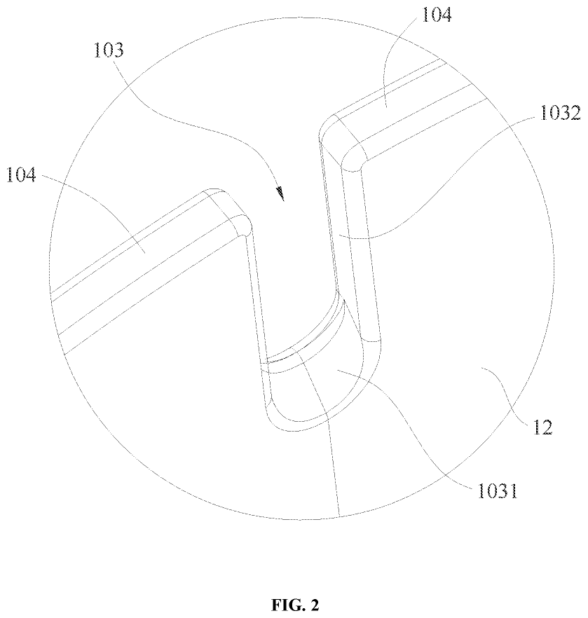

In an embodiment, referring to FIG. 2, the open groove 103 comprises a bottom wall 1031, and the bottom wall 1031 is inclined toward the liquid storage chamber 101 from an outside of the water storage tank body 10. In this case, the power line led out toward the outside of the liquid storage chamber 101 from the liquid storage chamber 101 can be inclined upward along the bottom wall 1031 to be placed in the open groove 103, which coincides with the trend that the power line extends upward to the open groove 103 from the bottom of the liquid storage chamber 101, prevents excessive lending of the power line, and improves the safety of the power line.

It is to be noted that the shape and the structure of the bottom wall 1031 are not limited thereto. In some other embodiments, the bottom wall 1031 may further be horizontal or inclined toward the outside of the water storage tank body 10 from the liquid storage chamber 101.

Further, in an embodiment, referring to FIG. 2, the open groove 103 comprises two sidewalls 1032 on two sides of the bottom wall 1031, the sidewalls 1032 are connected to end edges 104 of the water storage tank body 10, and the bottom wall 1031 and the two sidewalls 1032 are enclosed to form a channel for allowing the power line to pass through.

In an embodiment, referring to FIG. 2, the open groove 103 is provided with a bottom wall 1031, and the bottom wall 1031 is of an arc shape. The arc-shaped bottom wall facilitates the adaptation with the power line, such that the power line is better attached to the bottom wall 1031 and is not damaged for contacts with edges and corners, further improving the stability and safety of the power line.

It is to be noted that the shape of the bottom wall 1031 is not limited thereto. In some other embodiments, the bottom wall 1031 may further be of a planar shape.

In an embodiment, referring to FIG. 4 and FIG. 5, the water storage tank 100 includes a clamping portion 20, the clamping portion 20 is arranged on an outer surface of the water storage tank body 10, and the clamping portion 20 comprises a bayonet 201 for clamping the power line. The bayonet 201 is matched with the power line in shape and size to facilitate stable clamping of the power line. In this case, the power line led out to the outside of the liquid storage chamber 101 from the open groove 103 is conveniently clamped in the bayonet 201, preventing the stressed power line from swinging freely and making the power line more stable and regular. The clamping portion 20 may be integrally formed with the water storage tank body 10, and certainly, may also be split and connected to the water storage tank body 10. The clamping portion 20 may be of a hook shape. It may be a clip, and may also be a buckling portion hinged to the outer surface of the water storage tank body 10. The bayonet 201 is arranged on the buckling portion, and buckled on the outer surface of the water storage tank body 10 through the buckling portion, such that the power line is limited between the buckling portion and the outer surface of the water storage tank body 10. The clamping portion 20 may further be two buckling members capable of being opened and closed relatively; and the two buckling members are buckled to form the bayonet 201, thereby clamping the power line. However, there are no limits made thereto.

Further, in an embodiment, referring to FIG. 5, the clamping portion 20 corresponds to the open groove 103, such that the power line led out to the outside of the liquid storage chamber 101 from the open groove 103 can be clamped into the bayonet 201 to improve the stability during clamping.

Further, in an embodiment, referring to FIG. 4 and FIG. 5, the clamping portion 20 is located below the open groove 103, namely the open groove 103 is located between the opening 102 and the clamping portion 20. In this case, the power line led out to the outside of the liquid storage chamber 101 from the open groove 103 extends downward and is clamped into the bayonet 201; and the power line extends downward along the outer surface of the water storage tank body 10 and then is connected to a power source. Therefore, the power line is arranged more regularly and aesthetically.

In an embodiment, referring to FIG. 1, the water storage tank body 10 includes a bottom wall portion 11 and a sidewall portion 12, where the sidewall portion 12 is internally hollow; one end of the sidewall portion 12 is connected to the bottom wall portion 11, such that the sidewall portion 12 and the bottom wall portion 11 are enclosed to form the liquid storage chamber 101; the other end of the sidewall portion 12 services as the opening 102; the sidewall portion 12 may be integrally formed with the bottom wall portion 11; the open groove 103 is formed in the sidewall portion 12 and close to the opening 102; and the open groove 103 penetrates through an end edge 104 of the sidewall portion 12 close to the opening 102. Therefore, the water storage tank body 10 achieves the simple structure, with convenience in cleaning and low manufacturing cost.

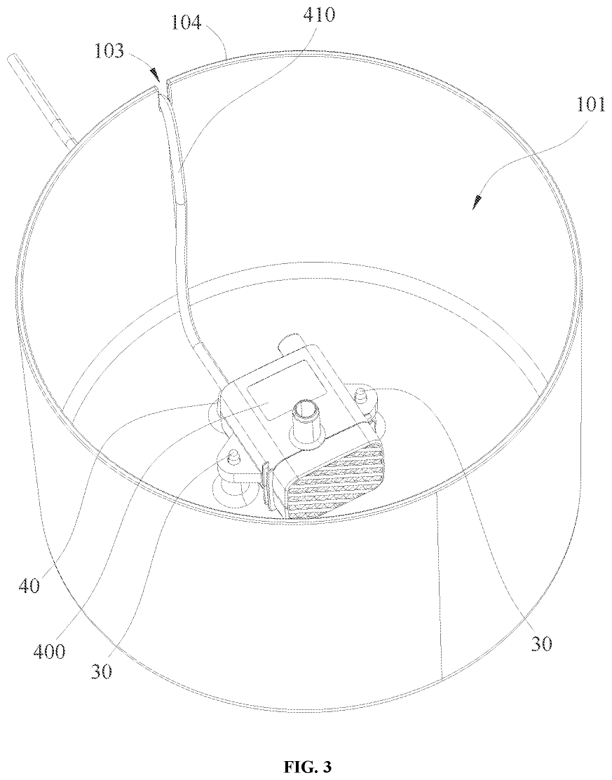

In an embodiment, referring to FIG. 1 and FIG. 3, the water storage tank 100 includes a connecting portion 30 connected to the water pump 400 of the animal water fountain, and the connecting portion 30 is located in the liquid storage chamber 101 and arranged on a bottom surface of the water storage tank body 10. The connecting portion 30 may be a clamping structure, a binding member, or a fastener such as the bolt and the screw, but is not limited thereto. In this case, the water pump is arranged in the liquid storage chamber 101 conveniently and more stably.

Further, in an embodiment, referring to FIG. 3, the water pump 400 comprises a locating hole, the connecting portion 30 is a locating post matching with the locating hole of the water pump 400, and the locating post protrudes from the bottom surface of the water storage tank body 10. In this case, the water pump 400 can be located and mounted as long as the locating post passes through the locating hole of the water pump 400, which makes the water pump 400 mounted and dismounted more conveniently. Further, there may be two or more locating posts to improve the stability of the water pump 400.

In an embodiment, referring to FIG. 1 and FIG. 3, the water storage tank includes a limiting portion 40 for limiting the water pump 400, and the limiting portion 40 is located in the liquid storage chamber 101 and arranged on a bottom surface of the water storage tank body 10. The limiting portion 40 may be a limiting protrusion portion such as the plate-like protrusion and cylindrical protrusion. In this case, the water pump 400 in the liquid storage chamber 101 can be limited by the limiting portion 40, to achieve better convenience and stability of the water pump 400 in mounting. Further, a limiting space for receiving the water pump is formed between the limiting portion 40 and the connecting portion 30.

In an embodiment, referring to FIG. 1, the water storage tank body 10 is of a cylindrical shape, such that the water storage tank body 10 has less edges or corners and is smoother, for ease of cleaning.

It is to be noted that the shape of the water storage tank body 10 is not limited thereto. In some other embodiments, the water storage tank body 10 may also be of a rhombic shape such as the rectangular shape, and may further be of other regular or irregular shapes.

Therefore, according to the water storage tank 100 provided by the embodiment of the disclosure, the power line of the water pump can extend to the outside through the open groove 103 and thus is led out from the liquid storage chamber 101. Since the open groove 103 penetrates through the end edge 104 of the water storage tank body 10 close to the opening 102, and the power line can be led out from the liquid storage chamber by directly clamping into the open groove 103 from top to bottom, the power line is arranged conveniently and there is no need to provide the wiring box or the wiring groove for the power line; the water pump and the power line thereof are assembled quickly and conveniently on the water storage tank and there is no need to additionally provide the wiring box or the wiring groove, so the water storage tank provided by the embodiment of the disclosure can effectively reduce the manufacturing cost and improve the assembly efficiency as well as the production efficiency of the animal water fountain; and moreover, since the power line can be led out by only providing the open groove 103, the disclosure effectively simplifies the structure of the water storage chamber, for ease of cleaning. Additionally, since the open groove 103 is close to the opening 102, the upper portion of the power line can extend upward from the liquid level in the liquid storage chamber 101 and thus is led out from the liquid storage chamber 101; and therefore, compared with the scheme in which the wiring box or the wiring groove is formed in the bottom or the inner surface of the water storage tank in the prior art, the disclosure is safer. Meanwhile, when the drinking water tray and the water filter tray of the animal water fountain are arranged on the water storage tank body 10 and close the opening 102, the open groove 103 can be sealed, such that the power line can be limited in the open groove 103 to make it more stable. Therefore, the water storage tank 100 provided by the embodiment of the disclosure effectively solves the technical problem that the power line of the water pump is arranged on the water storage tank inconveniently in the prior art.

Referring to FIG. 4 and FIG. 5, the embodiment of the disclosure further provides an animal water fountain 1000. The animal water fountain 1000 includes the water storage tank 100 in any of the above described embodiments; a water filter tray 200, a drinking water tray 300 and a water pump 400.

The water filter tray 200 is arranged on the water storage tank 100. Specifically, the water filter tray 200 is arranged on the water storage tank body 10 and close to the opening 102 and can be directly supported on the end edges 104 of the sidewall portion 12, or a seating groove for providing the water filter tray 200 is formed in an inner wall of the water storage tank body 10. The water filter tray 200 includes a filtrate chamber 210; a filter element 220 is arranged in the filtrate chamber 210; the water filter tray 200 comprises a filtrate outlet 230; and the filtrate chamber 210 communicates with the liquid storage chamber 101 of the water storage tank 100 through the filtrate outlet 230, such that the filtered liquid flows back to the liquid storage chamber 101.

The drinking water tray 300 is arranged on the water filter tray 200 or the water storage tank 100; the water filter tray 200 is located between the drinking water tray 300 and the water storage tank; the drinking water tray 300 includes a liquid accommodation chamber 310; a liquid for animal drinking may be accommodated in the liquid accommodation chamber 310; the drinking water tray 300 comprises a water leaking port 320 communicating with the liquid accommodation chamber 310; and the liquid accommodation chamber 310 communicates with the filtrate chamber 210 through the water leaking port 320, such that the liquid flowing to the water leaking port 320 from the liquid accommodation chamber 310 is leaked to the filtrate chamber 210 for filtering. The drinking water tray 300 comprises a suction pipe 330; the suction pipe 330 comprises a water inlet 3301 and a water outlet 3302; and an end, where the water outlet 3302 is located, of the suction pipe 330 is connected to the drinking water tray 300 and communicates with the liquid accommodation chamber 310, and an end, where the water inlet 3301 is located, of the suction pipe 330 is connected to an output end of the water pump 400.

The water pump 400 is arranged in the liquid storage chamber 101 to pump the liquid in the liquid storage chamber 101 to the liquid accommodation chamber 310; and the output end of the water pump 400 communicates with the water inlet 3301 of the suction pipe 330 of the drinking water tray 300. The water pump 400 comprises a power line 410, and the power line 410 passes through the open groove 103 of the water storage tank 100.

With the use of the water storage tank 100 in the above embodiment, the animal water fountain 1000 provided by the embodiment of the disclosure achieves the same technical effects obtained from the technical solutions of the water storage tank 100 in the above embodiment, namely the power line 410 of the water pump 400 can be led out from the liquid storage chamber by directly clamping into the open groove 103 of the water storage tank 100 from top to bottom, the water pump and the power line thereof are assembled quickly and conveniently on the water storage tank, the manufacturing cost is effectively reduced, the assembly efficiency is improved, and the structure of the water storage tank is effectively simplified.

The above descriptions are merely preferred embodiments of the disclosure, and are not intended to limit the disclosure. Any modification, equivalent substitute and improvement without departing from the spirit and principle of the disclosure shall be included within the protection scope of the disclosure.

What is claimed is:

1. A water storage tank, applied to an animal water fountain comprising a water pump having a power line, wherein the water storage tank comprises a water storage tank body; the water storage tank body is defined with a liquid storage chamber for storing a liquid and for receiving the water pump, and an opening communicating with the liquid storage chamber; an open groove for allowing the power line to pass through is formed in the water storage tank body; and the open groove penetrates through an end edge of the water storage tank body close to the opening.

2. The water storage tank according to claim 1, wherein the open groove comprises a bottom wall, and the bottom wall is inclined toward the liquid storage chamber from an outside of the water storage tank body.

3. The water storage tank according to claim 1, wherein the open groove is comprises a bottom wall, and the bottom wall is of an arc shape.

4. The water storage tank according to claim 1, wherein the water storage tank comprises a clamping portion, the clamping portion is arranged on an outer surface of the water storage tank body, and the clamping portion comprises a bayonet for clamping the power line.

5. The water storage tank according to claim 1, wherein the water storage tank body comprises:
a bottom wall portion; and
a sidewall portion, wherein the sidewall portion is internally hollow; one end of the sidewall portion is connected to the bottom wall portion, such that the sidewall portion and the bottom wall portion are enclosed to form the liquid storage chamber; the other end of the sidewall portion services as the opening; the open groove is formed in the sidewall portion and close to the opening; and the open groove penetrates through an end edge of the sidewall portion close to the opening.

6. The water storage tank according to claim 1, wherein the water storage tank comprises a connecting portion connected to the water pump, and the connecting portion is located in the liquid storage chamber and arranged on a bottom surface of the water storage tank body.

7. The water storage tank according to claim 6, wherein the water pump is defined with a locating hole, the connecting portion is a locating post matching with the locating hole of the water pump, and the locating post protrudes from the bottom surface of the water storage tank body.

8. The water storage tank according to claim 1, wherein the water storage tank comprises a limiting portion for limiting the water pump, and the limiting portion is located in the liquid storage chamber and arranged on a bottom surface of the water storage tank body.

9. The water storage tank according to claim 1, wherein the water storage tank body is of a cylindrical shape.

10. An animal water fountain, comprising:
the water storage tank according to claim 1;
a water filter tray, arranged on the water storage tank, and comprising a filtrate chamber, the filtrate chamber communicating with the liquid storage chamber of the water storage tank;
a drinking water tray, arranged on the water filter tray or the water storage tank, wherein the water filter tray is located between the drinking water tray and the water storage tank, the drinking water tray comprises a liquid accommodation chamber, and the liquid accommodation chamber is communicated with the filtrate chamber; and
a water pump, arranged in the liquid storage chamber to pump a liquid in the liquid storage chamber to the liquid accommodation chamber, wherein the water pump comprises the power line, and the power line penetrates through the open groove of the water storage tank.
